(19) United States
(12) Patent Application Publication
(10) Pub. No.: US 2023/0328015 A1
(43) Pub. Date: Oct. 12, 2023

(54) TECHNIQUE FOR EXCHANGING INFORMATION BETWEEN AT LEAST TWO COMMUNICATION ENTITIES

(71) Applicant: retarus GmbH, Muenchen (DE)

(72) Inventors: Martin HAGER, Muenchen (DE); Michael GRAUVOGL, Muenchen (DE); Reimund KLAIN, Muenchen (DE)

(21) Appl. No.: 18/044,266

(22) PCT Filed: Oct. 22, 2020
(86) PCT No.: PCT/EP2020/079697

§ 371 Date: Mar. 7, 2023

(51) Int. Cl. H04L 51/08

(52) U.S. Cl. CPC H04L 51/08

(57) ABSTRACT

The disclosure relates to a method and a server of exchanging information. The method includes receiving a first electronic message from a first communication entity, the first electronic message is in a first message format and includes content data related to a commercial process; extracting content data from the first electronic message and storing it in a database; generating a second electronic message in a second message format for the second communication entity based on the extracted content data, the second electronic message includes a notification that content data related to the commercial process is available, and a link to direct the second communication entity to a web portal; transmitting the second electronic message to the second communication entity; and rendering at least a part of the extracted content data on the web portal and providing access to the rendered content data on the web portal.

### TECHNICAL FIELD

The present disclosure relates generally to communication technology. In particular, the disclosure relates to a technique of exchanging information between at least two communication entities.

### BACKGROUND

Electronic data interchange, or in short EDI, has been developed since the early 1970s in order to automate and replace traditional communication using paper. EDI can be defined as the transfer of structured data by agreed message standards from one computer system to another without human intervention. Different EDI standards have been developed, such as UN/EDIFACT, ODETTE, ANSI ASC X.12 etc., for transferring data or messages associated with commercial processes, such as purchase orders, request for quotations (or RFQ), shipping notices, payment advices etc. between communication entities such as customers and suppliers. The implementation of EDI has the following advantages. As the data transfer between the two communication entities is fully automated, they do not need a human interpretation and, therefore, EDI is fast, cost saving and reliable, because it reduces or eliminates manual data entry errors.

However, the adaptation of EDI comes along with some considerable drawbacks, in particular when peer-to-peer EDI has to be implemented. In such a case, the entities (i.e., customer and supplier) communicating with each other have to implement corresponding EDI systems, i.e. communication hardware and software, which are compatible with each other and capable of converting exchanged EDI messages into data formats that can be imported into the entity's ERP (Enterprise-Resource-Planning) systems. Implementation of corresponding EDI software and hardware is associated with considerable costs end effort and is often not worthwhile for small suppliers with few messages/transactions.

Accordingly, there is a need for a new technique capable of exchanging information/data between at least two communication entities in a reliable way, which at least overcomes the above-mentioned drawbacks of standard EDI systems.

### SUMMARY

According to a first aspect, a method of exchanging information between at least two communication entities is provided, wherein the method is performed by a server which is in communication with the at least two communication entities. The method comprises the steps of: receiving a first electronic message from a first communication entity, the first electronic message being received in a first message format and comprising content data related to a commercial process; extracting content data from the first electronic message and storing the extracted content data in at least one database; generating a second electronic message in a second message format for the second communication entity based on the extracted content data, wherein the second electronic message at least comprises a notification that content data related to the commercial process is available, and a link generated by the server to direct the second communication entity to a web portal of the server upon opening of the link; transmitting the second electronic message to the second communication entity; and rendering at least a part of the extracted content data on the web portal and providing access to the rendered content data on the web portal upon opening of the link.

Within the present disclosure the term “commercial process” encompasses any commercial interaction or activity between at least two trading partners (e.g., a customer and a supplier in the context of a customer-supplier-chain), such as a request of quotation (RFQ), a bid in response to a RFQ, purchase order, purchase order acknowledgement, shipping notice, receiving advice, invoice, payment advice etc.

Accordingly, a first electronic message that comprises “content data related to a commercial process” is a message that comprises data/information about at least one of the above-listed commercial processes. Further, such a first electronic message may additionally comprise content data (information) related to the first communication entity (e.g., the supplier name, address, telephone number, email and/or URL) and/or content data (information) related to the second communication entity (e.g., customer's name, address, telephone number, email and/or URL) for which the messages are intended.

The first communication entity may be an electronic system, such as a (distributed) computer system or computer terminal associated with a first communication party, such as a customer. In a similar way, the second communication entity may be an electronic system, such as a second (distributed) computer system or computer terminal associated with a second communication party, such as a supplier. Further, the server may be a (distributed) computer system, which is in communication with the at least two communication entities via a data communication network, such as the Internet, or other communications channels. The server is designed to implement corresponding software and/or hardware functionalities for carrying out the above described method. The server and its functionalities will be described in more detail below.

The method may further comprise the step of (dynamically) generating and transmitting a third message to the first communication entity in response to at least one of a confirmation or refusal input, data content editing, document download and document upload performed by the second communication entity on the web portal. The second communication entity may perform a confirmation or refusal input (for instance, by clicking on a confirm or refusal button on the web portal) to confirm or refuse the rendered content data and, therefore, the commercial process associated with the content data. Further, the second communication entity may perform a content data editing on the web portal to change or modify the rendered content data and, therefore, the commercial process associated with the content data. Further, the second communication entity may activate a data upload functionality (e.g., by clicking on an upload link) on the web portal to upload one or more documents on the web portal. Still further, the second communication entity may activate a data download functionality (e.g., by clicking on a download link) on the web portal to download one or more documents that have been made available on the web portal. Accordingly, the third message is a message that is dynamically generated by the server upon reception of a feedback (such as the above-mentioned confirmation input, data editing, upload/download of new documents) from the second communication entity. This response message is generated by the server in the first data format and is indicative of a confirmation, refusal or change of the content data communicated by the first communication entity to the server via the first electronic message. Moreover, if a new document is uploaded by the second communication entity, the server may attach the uploaded document to the server. Still further, if no feedback is received from the second communication entity to the rendered content data within a certain period of time, the server may nevertheless generate a response message (i.e., the third message) indicating that the first electronic message of the first electronic entity has been ignored by the second electronic entity.

The first electronic message generated in the first message format may be different from the second electronic message generated in the second message format. More specifically, the first electronic message may be different from the second electronic message at least in terms of the used message format. For instance, the first message format can be an EDI-(electronic data interchange) format, such as UN/EDIFACT or the ODETTE-format. Other message formats or standards are also conceivable. Alternatively, the first message format may be a hybrid EDI-format that supports the attachment of one or more documents related to the commercial process. Such documents may be available in a specific file format, such as pdf-format, docx-format, csv-format xlsx-format, and so on.

The first electronic message may be transmitted via Internet using a standard transmission protocol, such as SMTP or IMAP/POP or FTP. For instance, it is conceivable that the first electronic message is transmitted as mail message from the first communication entity to the server.

The second electronic message may be generated as electronic mail message. The mail message may be dynamically generated by the server based on the content data extracted from the first electronic message. As described above, the content data extracted from the first electronic message may comprise the email address of the second communication entity for which the first electronic message is intended. The extracted email address may be used in order to generate the second electronic message. Moreover, a text message may be generated that notifies the second communication entity that content data related to a commercial process is available on the sever. Still further, an electronic link is dynamically generated by the server and embedded in or added to the notification text.

If the second electronic message is a mail message, the second message format may be a mail message format that further supports the attachment of at least one document, such as a pdf-document, xlsx-document, docx-document, etc. Accordingly, if required, the second message can comprise at least one attached document in addition to the notification text and the electronic link.

The electronic link may be a hyperlink that points to the rendered content on the web portal of the server. According to one implementation, the electronic link may comprise a universally unique identifier (UUID) generated by the server for that specific content and the second communication entity. The generation of a link with a universally unique identifier has the advantage that the second communication entity has direct access to the rendered content on the web portal without having to carry out a login process (i.e., insertion of login name and login password).

Further, the generated electronic link may be activated over a predetermined period of time. This predetermined period of time may be set by the server or by the first communication entity generating the message for the second communication entity. This period of time may be set to be equal to or greater than the validity period of a commercial process. In practice, the predetermined period of time may be set to be in the range of a few days up to several weeks. As long as the link is in an active state, the second communication entity can open the link and get access to the content data rendered on the web portal.

The web portal is provided by the server. It is a software module (software application) that implements a rendering functionality configured to dynamically render content data extracted from the first electronic message and stored in the at least one database when the second communication entity accesses the web portal (i.e., by opening the electronic link in the second electronic message). The rendering may comprise at least one of the following sub-steps: reading extracted content data that can be associated with the electronic link from the at least one database, grouping the extracted content data according to predefined criteria, and displaying the grouped content data in different areas (or tables) on the web portal. The grouping of the extracted content data according to predefined criteria may include grouping the extracted content data related to the first communication entity (supplier), content data related to the second communication entity (customer) and content data related to the commercial process into different groups. Moreover, the displaying of the grouped content data may include generating different tables for each group of content data and displaying each group of content data in a specific table. For instance, the content data related to the first communication entity, the content data related to the second communication entity as well as the content data related to the commercial process may be displayed in separate tables on the web portal. Still further, the rendering of content data related to commercial processes may include rendering bar codes, QR-codes or Data Matrix-codes that are associated with corresponding purchase items. The rendered codes can be easily read out by a corresponding code reader.

Further, the web portal may be designed to additionally implement at least one of the following functionalities: a content data confirmation functionality, a content data editing functionality, a comments functionality, a download functionality, an upload functionality, and a printing functionality.

The content data confirmation functionality may be implemented in the form of a confirmation button on the web portal, which can be pressed by a user of the second communication entity. By clicking on the confirmation button, the rendered content data can be confirmed in a simple and fast manner. After confirmation of the rendered content data they may no longer be modifiable by a user of the second communication entity.

The content data editing functionality may be implemented by the web portal in the form of at least one editing field that allows a direct modification of content data on the web portal. The modified content data may be stored in the database after confirmation. Moreover, the modified content data may be included in the third response message generated by the server for the first communication entity.

The comments functionality may be implemented in the form of an input field through which a user of the second communication entity can input comments relating to a commercial process. The inputted comments may be stored in the server database after confirmation. Moreover, the inputted comments may be included in the third message (i.e., response message) generated by the server for the first communication entity.

The download functionality may be implemented in the form of at least one download link on the web portal. By clicking on this download link, a user of the second communication entity can directly download commercial documents transmitted by the first communication entity and provided by the server.

The upload functionality may be implemented in the form of at least one upload link on the web portal. By clicking on this upload link a user of the second communication entity can directly upload its own commercial documents on the server. The server may communicate the uploaded documents to the first communication entity by attaching these documents to the third electronic message (i.e., response message) or by generating a separate message.

Further, the printing functionality may be implemented by a printing button that can be clicked to print the rendered content data.

The step of storing the extracted content data may comprise structuring the extracted content data according to predefined rules and storing the structured content data in one or more relational tables. The predefined rules may define how the content data (and associated documents) are to be stored and referenced in the relational tables. Moreover, related content data or content data belonging to the same commercial process are stored such that the relation between the data is maintained. Alternatively or additionally, predefined rules may define which fields are changeable, rejectable, required to be filled or optional by the second communication entity. These rules can also be stored on a customer specific level, attributable to all processes or addressable on a line item level in which case the rules may be activated for example by a comment in the line item received in the first electronic message from the first communication entity.

According to a second aspect, a computer program product is provided that comprises program code portions for carrying out the above-described method, when the computer program product is executed on a computer device. The computer program product may be stored on a (non-transitory) computer-readable recording medium.

According to a third aspect, a server is provided that is configured to exchange information between at least two communication entities. The server is in communication with the at least two communication entities, wherein the server is configured to: receive, by a communication module, a first electronic message from a first communication entity, wherein the first electronic message is a message in a first message format and comprises content data related to a commercial process; extract, by a data extractor, the content data from the first electronic message; store the extracted content data in at least one database; generate, by a message generator, a second electronic message in a second message format for the second communication entity based on the extracted content data, wherein the second electronic message at least comprises a notification that content data related to a commercial process is available, and a link generated by the server to direct the second communication entity to a web portal of the server upon opening of the link; transmit the second electronic message to the second communication entity; and render, by a web portal, at least a part of the extracted content data, and provide access to the rendered content data displayed on the web portal upon opening of the link.

According to a fourth aspect, a system for exchanging information between at least two communications entities is provided. The system comprises: a first communication entity; a second communication entity; and the above-described server configured to exchange first and third messages with the first communication entity using a first message format, and to exchange a second message with the second communication entity using a second message format, wherein the server is further configured to provide a web portal for the second communication entity.

### BRIEF DESCRIPTION OF THE DRAWINGS

Further details, aspects and advantages of the present disclosure described herein will become apparent from the following drawings, in which:

FIG. 1 is a block diagram illustrating a system for exchanging information according to an exemplary embodiment of the present invention;

FIG. 2 is a block diagram illustrating a server configured to exchange information between at least two communication entities according to an exemplary embodiment of the present invention; and

FIG. 3 is a flow diagram illustrating a method of exchanging information between at least two communication entities according to an exemplary embodiment of the present invention.

### DETAILED DESCRIPTION

In the following description, for purposes of explanation and not limitation, specific details are set forth in order to provide for a thorough understanding of the technique presented herein. It will be apparent to one skilled in the art that the disclosed information exchange technique may be practised in other embodiments that depart from these specific details.

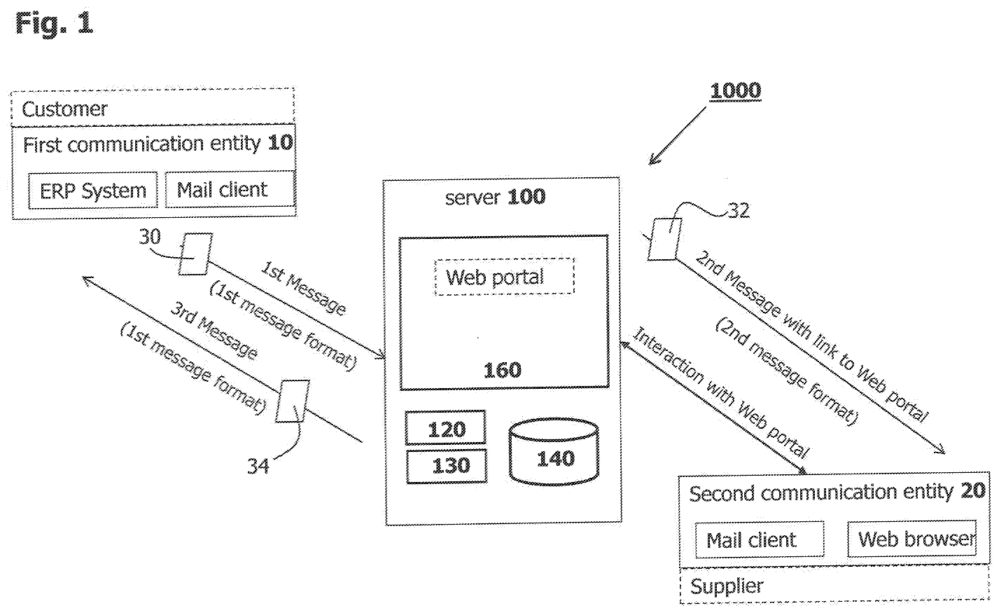

FIG. 1 illustrates, in the form of a block diagram, an exemplary embodiment of a system 1000, which can implement the below-described technique for exchanging information between at least two communication entities.

The system 1000 comprises a server 100, at least one first communication entity 10 as well as at least one second communication entity 20. The first communication entity 10 and the second communication entity 20 are in communication with the server 100, for instance over Internet or at least one other communication channel.

The first communication entity 10 may be a (distributed) computer system or a computer device. In a similar way, the second communication entity 20 may be a (distributed) computer system or computer device, which is in communication with the server 100. In the context of a customer-supplier-chain and a data exchange between a customer and a supplier, the first communication entity 10 may be associated with the customer, while the second communication entity 20 may be associated with the supplier. The first communication entity 10 may comprise its own enterprise resource planning (ERP) system that manages and stores content data related to commercial processes or commercial interactions. The terms commercial processes and commercial interactions are used synonymously as described above.

The first communication entity 10 further comprises data processing tools (not illustrated in FIG. 1) configured to select and read out content data from the ERP system and convert these data into messages according to a predefined first message format. This predefined first message format can be a standard EDI format such as the UN/EDIFACT standard. It is also conceivable that a hybrid EDI format is used that further supports the attachment of documents in a specific document file format, such as pdf-format, csv-format xlsx-format, etc. In such a case, the content data related to a commercial interaction with a supplier (i.e. the second communication entity 20) is structured in EDI message format and can be supplemented by corresponding documents in a specific format, for instance pdf-format.

The first communication entity 10 is further configured to transmit a generated EDI or hybrid EDI message as a first message 30 to the server 100 over an established communication channel. For instance, the first message 30 can be transmitted via a standard transmission protocol such as FTP, email, HTTP or other transmission technologies to the server 100. As shown in FIG. 1, the first communication entity 10 is also configured to receive messages from the server 100 in response to the earlier communicated first message 30. This response message is denoted as third message 34 in the present disclosure. The third message 34 may be a message in the first message format, i.e., in the EDI format or hybrid-EDI format agreed upon by the first communication entity 10 and the server 100.

The second communication entity 20 is configured to receive a second electronic message 32 in a second message format from the server 100. A second electronic message 32 is dynamically generated by the server 100 based on the content data received in the first electronic message 30 from the first communication entity 10. This message 32 includes an electronic link (e.g., a hyperlink), which directly provides access to content data intended for the second communication entity and rendered on a web portal 160 of the server 100. The second electronic message 32 may be an electronic mail message, and the second message format may be an email message format. This message format may support attachments of documents, such as pdf-documents, xlsx-documents, csv-documents, etc.

The second communication entity 20 may implement an email client in order to receive and read such a message. Still further, the second communication entity 20 may implement a web browser configured to visualize the content data rendered on the web portal of the server 100. A user of the second communication entity 20 can interact with the web portal 160 via the web browser. Moreover, the user of the second communication entity 20 gets access to the web portal 160 by opening the link to the web portal 160 embedded in the second electronic message 20. Hence, with the provided system 1000, the second communication entity 20 can exchange information/data with the first communication entity 10 via server 100 by using only a messaging client and a web browser. There is no need for the second communication entity 20 to implement EDI infrastructure in order to enable communication with the first communication entity 10.

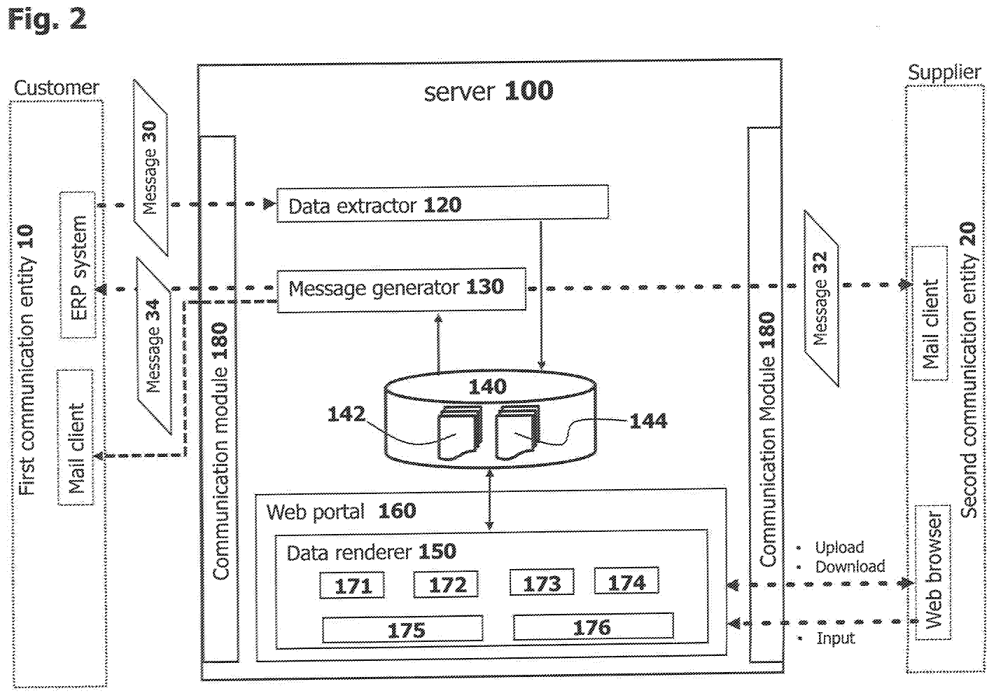

With reference to FIG. 2, the structure and functionality of the server 100 is further described.

The server 100 comprises at least one communication module 180 via which the server 100 is in communication with the first communication entity 10 and the second communication entity 20. The server 100 further comprises a data extractor 120, a message generator 130, a database 140 as well a web portal 160. The data extractor 120, the message generator 130 as well as the web portal 160 may be implemented as separate software modules, hardware modules or combined software/hardware modules. Alternatively, the data extractor 120, the message generator 130 and the web portal 160 can be implemented as sub-modules of a commonly designed software and/or hardware module. A person skilled in the art will appreciate that the above-mentioned modules may be implemented using software functioning in conjunction with a programmed microprocessor, using an application-specific integrated circuit (ASIC), digital signal processor (DSP) or a general purpose computer.

Regardless of the above-mentioned implementation details, the data extractor 120 is in communication with the communication module 180 and configured to extract content data from a first electronic message 30 received by the communication module 180 from the first communication entity 10. The data extractor 120 is further configured to store the extracted content data in a database storage 140. The database 140 may comprise one or more relational tables 142, 144, in which the extracted content data is stored maintaining the relationship between different content portions. In this context, it is important to note that content data related to a commercial interaction process is stored in the database 140 dynamically, i.e. upon receipt of a corresponding first electronic message 30 from the first communication entity 10.

The message generator 130 is in communication with the database 140. The message generator is configured to dynamically generate a second electronic message 32 for the second communication entity 20 based on the content data extracted from the first electronic message 30 and stored in the database 140. In this context, it is important to note that the message generator 130 is configured to generate the second electronic message 32 in a second message format, which can be interpreted by the second communication entity 20 and which may be different from the first message format of the first electronic message 30. This second message format can be a mail message format as described above. Moreover, the message generator 130 is configured to additionally generate the above-mentioned link to the web portal 160 and to add or embed this link in the second message. The generated link is associated with the content data extracted from the first electronic message 30 received from the first communication entity 10.

The web portal 160 is a software module (software application) that is in communication with the database 140. The web portal 160 implements a data renderer 150 (i.e., a data rendering functionality) configured to read out content data from the relational tables 142, 144 of the database 140 and render the read-out content data in a structured form (for instance, by generating content tables) on the web portal 160. This web portal 160 is accessible by the second communication entity 20, when a user of the second communication entity 20 opens the hyperlink embedded in the second communication message 32. Upon activating or opening of the link, the second communication entity 20 is directed to the web portal 160 of the server 100 and can view via a web browser the content rendered on the web portal 160.

The web portal 160 may implement additional functionalities, such as a data content confirmation functionality 171, a content data editing functionality 172, a comments functionality 173, a download functionality 174, an upload functionality 175 and a printing functionality 176. These functionalities support the second communication entity 20 in the modification, adding and confirmation of content data related to a commercial process. For instance, by using the data content editing functionality, a user of the second communication entity 20 can modify content data provided by the first communication entity 10 and rendered on the web portal 160. Still further, by using the upload functionality, a user of the second communication entity 20 can upload documents on the web portal 160. Still further, by using the download functionality, a user of the second communication entity 20 can download documents provided on the web portal 160. Still further, by using the printing functionality, a user of the second communication entity 20 can make a print-out of the rendered content data on the web portal 160. Still further, by using the comments functionality, a user of the second communication entity 20 can comment on content data provided on the web portal 160. Moreover, the server 100 is configured to store the comments, edited content data and/or uploaded documents performed by the second communication entity 20 in the database 140.

The web portal 160 of the server 100 provides a flexible tool for the second communication entity 20 to monitor, modify and/or add data content or documents related to commercial processes. There is no need for the second communication entity 20 to technically implement an EDI system which is capable to communicate with the first communication entity 10. The implementation of a mail client and web server is sufficient in order to interact with the first communication entity 10 without restrictions. It is further important to note that the content data are dynamically rendered in the web portal 160 and access to the web portal 160 is obtained by activating the link transmitted over the second electronic message 32. There is no need to put in login credentials by the second communication entity so that the communication between the server 100 and the second communication entity 20 is simplified. With regard to the server 100, there is no need to save and administrate user credentials, because access to the web portal 160 is provided through the web link. Still further, there is no need to generate and maintain static data structures containing client and supplier data, article data etc., because all relevant content data associated with a commercial process can be dynamically generated by the server 100 upon receiving a first electronic message 30 from the first communication entity 10 as well as dynamically rendered in the web portal 160 for access by the second communication entity 20.

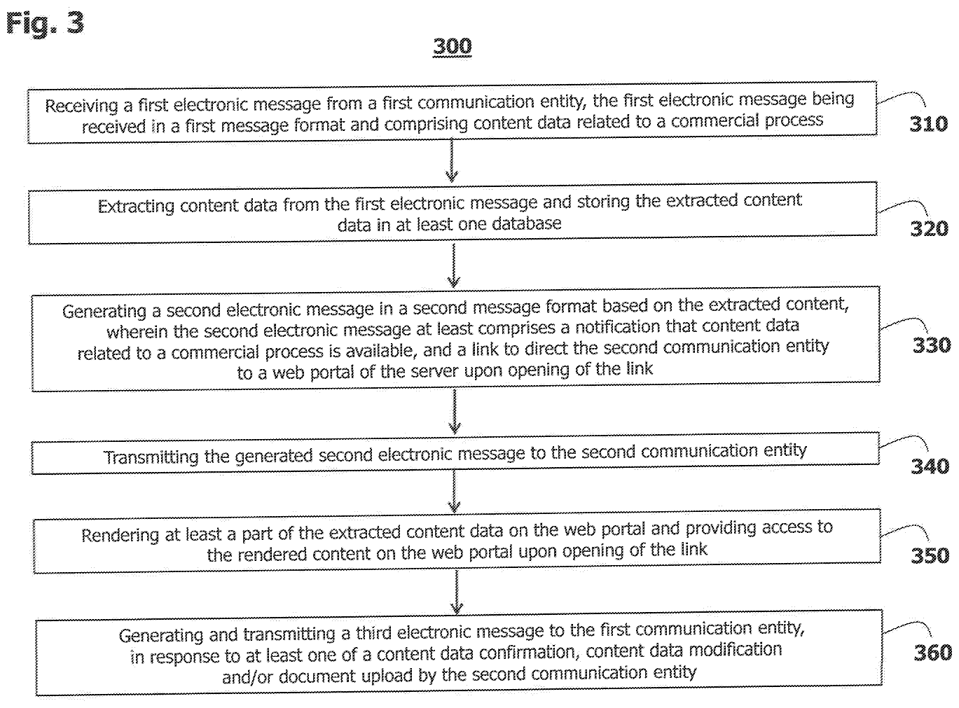

In conjunction with FIG. 3 a method 300 of exchanging information between the first communication entity 10 and the second communication entity 20 is further described. The method 300 is performed by the server 100 and comprises the following steps.

The method starts with step 310 in FIG. 3, according to which the server 100 receives via the communication module 180 a first electronic message 30 from the first communication entity 10. The first electronic message 30 is in a first message format and comprises content data related to a commercial process. As already described in conjunction with FIGS. 1 and 2 above, the first message format may be an EDI format or hybrid EDI format, which supports the attachment of documents. As further already described in conjunction with FIGS. 1 and 2 above, the content data are related to a commercial process, such as a purchase order, request for quotation (RFQ), a shipping notice, an invoice etc. The content data comprise data related to the first communication entity 10 (e.g. supplier email, address, etc.), data related to the second communication entity 20 (e.g. customer email, address, etc), and data related to the commercial process or interaction (e.g. RFQ data or purchase items) involving the customer and supplier.

In a subsequent step 320, the first electronic message 30 is routed to the data extractor 120. The data extractor 120 extracts the relevant content data of the first electronic message 30 and stores the extracted content data in the database 140.

In a subsequent step 330, the message generator 130 generates a second electronic message 32 in a second message format based on the content data extracted from the first electronic message 30. The second electronic message 32 is generated for the second communication entity 20 (i.e. the supplier), and at least comprises a notification that content data related to a commercial process is available. Moreover, the second electronic message 32 comprises a link (hyperlink) configured to direct the second communication entity 20 to the web portal 190 of the server 100 when the link is opened by the second communication entity 20 (or a user of the second communication entity 20). The link is generated by the message generator 130 and added or embedded into the second electronic message 32. The link comprises a universally unique identifier, or in short UUID, which is uniquely generated for that specific content data and for the second communication entity. Accordingly, by opening the link, the second communication entity 20 has the possibility to directly access the web portal 160 provided by the server 100 without having to input any login credentials. It is important to note that the generated link comprising the UUID is unique for the specific content and for the second communication entity 20 (supplier), for which the content is intended. Hence, with the described technique to embed a link in the second electronic message 32 it is ensured that only the supplier for which the content is intended has access to that specific content.

In a subsequent step 340, the generated electronic message is transmitted to the second communication entity 20. Hence, a user of the second communication entity has the possibility to access the web portal of the server 100 by clicking on (i.e. opening) the link.

In a subsequent step 350, upon opening of the link by a user of the second communication entity 20, or in short by the second communication entity 20, the second communication entity 20 has access to the web portal 160. Moreover, the web portal 160 renders the content data extracted from the first electronic message 30 and intended for the second communication device 20. Moreover, as already described in conjuncts tion with FIGS. 1 and 2 above, the web portal 160 may implement additional functionalities giving the second communication entity 20 the possibility to confirm, refuse or modify content data provided on the web portal 160 or to download or upload documents.

Further, in an optional step 360, a third electronic message 34 to the first communication entity 10 may be generated by the message generator 130, in response to at least one of a content data confirmation, content data modification and/or document upload by the second communication entity 20.

The above-described technique for exchanging information between two communication entities has the advantage that both communication entities do not have to agree to a common messaging standard. Each communication entity can use its own messaging standard. Moreover, the second communication entity can directly communicate with the first communication entity using the web portal provided by the server. For this purpose, the second communication entity only needs to implement a browser and a mail client in order to receive mails from the server. A further advantage of the described technique is that the second communication entity has direct access to the web portal via the web link received from the server. There is no need to input login credentials in order to get access to the web server. Still further, the described technique is beneficial from the point of view that the rendering of the extracted content data is performed dynamically, i.e. based on the incoming messages containing the content data. There is no need to maintain huge static databases containing article data as well as client and supplier data.

1. A method of exchanging information between at least two communication entities, the method being performed by a server which is in communication with the at least two communication entities, the method comprising:
receiving a first electronic message from a first communication entity, the first electronic message being received in a first message format and comprising content data related to a commercial process;
extracting content data from the first electronic message and storing the extracted content data in at least one database;
generating a second electronic message in a second message format for the second communication entity based on the extracted content data, wherein the second electronic message at least comprises a notification that content data related to the commercial process is available and a link generated by the server to direct the second communication entity to a web portal of the server upon opening of the link;
transmitting the second electronic message to the second communication entity; and
rendering at least a part of the extracted content data on the web portal and providing access to the rendered content data on the web portal upon opening of the link.

2. The method according to claim 1, further comprising generating and transmitting a third message to the first communication entity in response to at least one of a confirmation or refusal input, data content editing, document download and document upload by the second communication entity.

3. The method according to claim 2, wherein the third message is generated in the first message format and indicative of at least one of a confirmation or refusal of the content data, change of the content data and availability of at least one new document related to the commercial process.

4. The method according to claim 1, wherein the first electronic message generated in the first message format is different from the second electronic message generated in the second message format.

5. The method according to claim 1, wherein the first message format is an EDI format or a hybrid EDI-format used by the first communication entity, wherein the hybrid EDI-format supports the attachment of documents related to the commercial process.

6. The method according to claim 4, wherein the first electronic message is transmitted via Internet using a standard transmission protocol.

7. The method according to any claim 1, wherein the second electronic message is an electronic mail message, and the second message format is a mail message format that supports attachments of documents related to the commercial process.

8. The method according to claim 1, wherein the link is a hyperlink pointing to the rendered content on the web portal of the server.

9. The method according to claim 1, wherein the link comprises a universally unique identifier uniquely generated for the rendered content and the second communication entity.

10. The method according to claim 1, wherein the link is activated over a predetermined period of time.

11. The method according to claim 1, wherein the web portal is provided by the server, and wherein the web portal is designed to additionally implement at least one of the following functionalities: a content data confirmation functionality, a content data editing functionality, a comments functionality, a download functionality, an upload functionality and a printing functionality.

12. The method according to claim 1, wherein the rendering at least a part of the extracted content data comprises at least one of the following: reading extracted content data from the at least one database, grouping the extracted content data according to predefined criteria, and displaying the grouped content data in different areas on the web portal.

13. The method according to claim 1, wherein the storing the extracted content data comprises structuring the extracted content data according to predefined criteria and storing the structured content data in one or more relational tables.

14. A computer program product comprising program code portions for carrying out the method according to claim 1, when the computer program product is executed on a computer device, such as the server.

15. The computer program product according to claim 14, the computer program product being stored on a computer-readable recording medium.

16. A server configured to exchange information between at least two communication entities, the server being in communication with the at least two communication entities, the server being configured to:
receive a first electronic message from a first communication entity, wherein the first electronic message is a message in a first message format and comprises content data related to a commercial process;
extract the content data from the first electronic message and to store the extracted content data in at least one database;
generate a second electronic message in a second message format for the second communication entity based on the extracted content data, wherein the second electronic message at least comprises a notification that content data related to the commercial process is available, and a link generated by the server to direct the second communication entity to a web portal of the server upon opening of the link;
transmit the second electronic message to the second communication entity; and
render at least a part of the extracted content data on the web portal, and provide access to the rendered content data displayed on the web portal upon opening of the link.

17. A system for exchanging information between at least two communication entities, the system comprising:
a first communication entity;
a second communication entity; and
the server of claim 16 configured to exchange first and third messages with the first communication entity using a first message format, and to exchange a second message with the second communication entity using a second message format, wherein the server is further configured to provide a web portal for the second communication entity.
